(19) United States
(12) Patent Application Publication
(10) Pub. No.: US 2025/0373832 A1
(43) Pub. Date: Dec. 4, 2025

(54) POINT CLOUD FILE PROCESSING

(71) Applicant: TENCENT TECHNOLOGY (SHENZHEN) COMPANY LIMITED, Shenzhen (CN)

(72) Inventor: Ying HU, Shenzhen (CN)

(73) Assignee: TENCENT TECHNOLOGY (SHENZHEN) COMPANY LIMITED, Shenzhen (CN)

(21) Appl. No.: 19/297,981

(22) Filed: Aug. 12, 2025

Related U.S. Application Data
(63) Continuation of application No. PCT/CN2024/095467, filed on May 27, 2024.

(30) Foreign Application Priority Data
May 31, 2023 (CN) 202310634707.7

(51) Int. Cl. H04N 19/44; H04N 19/597

(52) U.S. Cl. CPC H04N 19/44; H04N 19/597

(57) ABSTRACT

Some aspects of the disclosure provide a method of processing a point cloud file. In some examples, the point cloud file encapsulating a point cloud bitstream is acquired. A data box of the point cloud bitstream includes a unit type field that indicates a data type from a plurality of data types for at least a data unit in the point cloud bitstream. The point cloud file is decapsulated. The point cloud file is decoded according to the unit type field to obtain point cloud media content, the point cloud media content is obtained from at least the data unit of the data type when the data type is a specified data type of the plurality of data types. Apparatus and non-transitory computer-readable storage medium counterpart embodiments are also contemplated.

### RELATED APPLICATIONS

The present application is a continuation of International Application No. PCT/CN2024/095467, filed on May 27, 2024, which claims priority to Chinese Patent Application No. 202310634707.7, filed on May 31, 2023. The entire disclosures of the prior applications are hereby incorporated by reference.

### FIELD OF THE TECHNOLOGY

This disclosure belongs to the field of point cloud media technologies, including a point cloud file processing method and apparatus, a computer-readable medium, an electronic device, and a computer program product.

### BACKGROUND OF THE DISCLOSURE

A point cloud is a set of irregularly distributed discrete points in space that represents a spatial structure and a surface attribute of a three-dimensional object or scene. After large-scale point cloud data is acquired by using a point cloud acquisition device, the point cloud data may be encoded and encapsulated for transmission to a user, and decoded and presented on a client.

In a data bitstream of a point cloud, if data of a plurality of different attribute types is encapsulated within a same data structure, the data structure needs to be completely decoded to obtain all the data of the attribute types, resulting in poor data access flexibility.

### SUMMARY

This disclosure provides a point cloud file processing method and apparatus, a computer-readable medium, an electronic device, and a computer program product, to effectively optimize data access flexibility of a point cloud file.

Some aspects of the disclosure provide a method of processing a point cloud file. In some examples, the point cloud file encapsulating a point cloud bitstream is acquired. A data box of the point cloud bitstream includes a unit type field that indicates a data type from a plurality of data types for at least a data unit in the point cloud bitstream. The point cloud file is decapsulated. The point cloud file is decoded according to the unit type field to obtain point cloud media content, the point cloud media content is obtained from at least the data unit of the data type when the data type is a specified data type of the plurality of data types. The decoding can skip decoding one or more data units in the point cloud bitstream that are of a different data type from the specified data type.

Some aspects of the disclosure provide a point cloud file processing apparatus that includes processing circuitry configured to perform the point cloud file processing method.

Some aspects of the disclosure also provide a non-transitory computer-readable storage medium storing instructions which when executed by at least one processor cause the at least one processor to perform the point cloud file processing method.

In an aspect, embodiments of this disclosure provide a point cloud file processing method, which includes: acquiring a point cloud file carrying a point cloud bitstream, a data box of the point cloud bitstream including a unit type field, and the unit type field indicating a data type of a data unit in the point cloud bitstream; and decapsulating and decoding the point cloud file according to the unit type field, to obtain point cloud media content corresponding to the data unit.

In an aspect, the embodiments of this disclosure provide a point cloud file processing apparatus, which includes: a first acquisition module, configured to acquire a point cloud file carrying a point cloud bitstream, a data box of the point cloud bitstream including a unit type field, and the unit type field indicating a data type of a data unit in the point cloud bitstream; and a decoding module, configured to decapsulate and decode the point cloud file according to the unit type field, to obtain point cloud media content corresponding to the data unit.

In an aspect, the embodiments of this disclosure provide a point cloud file processing method, which includes: acquiring point cloud media content; and encoding and encapsulating the point cloud media content, to obtain a point cloud file carrying a point cloud bitstream, a data box of the point cloud bitstream including a unit type field, and the unit type field indicating a data type of a data unit in the point cloud bitstream.

In an aspect, the embodiments of this disclosure provide a point cloud file processing apparatus, which includes: a second acquisition module, configured to acquire point cloud media content; and an encoding module, configured to encode and encapsulate the point cloud media content, to obtain a point cloud file carrying a point cloud bitstream, a data box of the point cloud bitstream including a unit type field, and the unit type field indicating a data type of a data unit in the point cloud bitstream.

In an aspect, the embodiments of this disclosure provide a computer-readable medium (e.g., non-transitory computer-readable medium), which has a computer program stored therein. A processor executes the computer program to implement the point cloud file processing method in the foregoing technical solutions.

In an aspect, the embodiments of this disclosure provide an electronic device, which includes: a processor (an example of processing circuitry); and a memory, configured to store executable instructions of the processor. The processor is configured to execute the executable instructions to implement the point cloud file processing method in the foregoing technical solutions.

In an aspect, the embodiments of this disclosure provide a computer program product, which includes a computer program. A processor executes the computer program to implement the point cloud file processing method in the foregoing technical solutions.

According to the technical solutions provided in the embodiments of this disclosure, the unit type field is defined in the data box of the point cloud bitstream, and the data type of the data unit in the point cloud bitstream may be indicated based on the unit type field. In this way, some data units that are in the point cloud file and that are of a specified data type may be selectively decoded according to the data type indicated by the unit type field. Therefore, data access flexibility of the point cloud file can be optimized.

### BRIEF DESCRIPTION OF THE DRAWINGS

FIG. 1 is a schematic diagram of a system architecture of point cloud media encoding/decoding in an application scenario according to an embodiment of this disclosure.

FIG. 2 is a flowchart of operations of a point cloud file processing method according to an embodiment of this disclosure.

FIG. 3 is a diagram of a point cloud file obtained through multi-track encapsulation based on a component type according to an embodiment of this disclosure.

FIG. 4 is a diagram of a point cloud file obtained through single-track encapsulation according to an embodiment of this disclosure.

FIG. 5 is a diagram of a point cloud file obtained through multi-track encapsulation based on a point cloud slice according to an embodiment of this disclosure.

FIG. 6 is a diagram of a point cloud file obtained by simultaneously encapsulating geometry data and attribute data of a point cloud slice within a single track according to an embodiment of this disclosure.

FIG. 7 is a flowchart of operations of a point cloud file processing method according to an embodiment of this disclosure.

FIG. 8 is a structural block diagram of a point cloud file processing apparatus on a decoder according to an embodiment of this disclosure.

FIG. 9 is a structural block diagram of a point cloud file processing apparatus on an encoder according to an embodiment of this disclosure.

FIG. 10 is a structural block diagram of a computer system suitable for implementing an electronic device according to an embodiment of this disclosure.

### DESCRIPTION OF EMBODIMENTS

The following describes technical solutions in embodiments of this disclosure with reference to the accompanying drawings. The described embodiments are some of the embodiments of this disclosure rather than all of the embodiments. Other embodiments are within the scope of this disclosure.

The block diagrams shown in the accompanying drawings are merely functional entities and do not necessarily correspond to physically independent entities. That is, the functional entities may be implemented in the form of software, or in one or more hardware modules or integrated circuits, or in different networks and/or processor apparatuses and/or microcontroller apparatuses.

The flowcharts shown in the accompanying drawings are example descriptions, and do not necessarily include all content and operations/processes and do not necessarily to be performed in the described orders either. For example, some operations/processes may be further divided, while some operations/steps may be combined or partially combined. Therefore, an actual execution order may change according to an actual condition.

In a specific implementation of this disclosure, user-related data, such as transmission content, decoded content, and consumption content of point cloud media, is involved. When the embodiments of this disclosure are applied to specific products or technologies, user permission or consent is required, and collection, use, and processing of the relevant data need to comply with relevant laws and regulations and standards of relevant countries and regions.

Examples of terms involved in the aspects of the disclosure are briefly introduced. The descriptions of the terms are provided as examples only and are not intended to limit the scope of the disclosure.

Relevant terms or abbreviations involved in the embodiments of this disclosure are explained below.

Audio Video Coding Standard (AVS): refers to the Chinese National AVS.

Moving Picture Experts Group (MPEG): refers an organization established by the International Standardization Organization (ISO) and the International Electrotechnical Commission (IEC) to develop international standards specially for moving picture and audio compression.

ISO based media file format (ISOBMFF): refers to a media file format that is based on the ISO standards. The ISOBMFF is an encapsulation standard for a media file, and the most typical ISOBMFF file is an MPEG-4 Part 14 (MP4) file.

Media segment: refers to a playable segment that conforms to a specific media format. During playback, the media segment may need to be used in conjunction with zero or a plurality of previous segments and an initialization segment.

Point cloud compression (PCC): refers to compression of a point cloud.

Video-based Point Cloud Compression (V-PCC): refers to PCC based on a related video encoding mode.

Geometry-based point cloud compression (G-PCC): refers to PCC based on a geometry model.

AVS-PCC: refers to PCC based on the Chinese National AVS.

Track: can refer to a media data set in an encapsulation process of a media file, and can include a plurality of time-ordered samples. One media file may include one or more tracks. For example, one media file typically includes a video media track, an audio media track, and a subtitle media track. In some examples, metadata information may also serve as a media type and is included in a file in the form of a metadata media track.

Sample: can refer to an encapsulation unit in an encapsulation process of a media file. In some examples, a track includes a plurality of samples, and each sample corresponds to specific timestamp information. For example, one video media track may include a plurality of samples, and one sample is typically one video frame. In the embodiments of this disclosure, one sample in a point cloud media track may be one point cloud frame.

Slice: can refer to a point cloud slice/point cloud strip, which can represent a set of syntax elements (such as geometry slices and attribute slices) of point cloud frame data after partial or full encoding.

Sequence header: can refer to a point cloud sequence header parameter set, which is a parameter set required when a point cloud sequence is decoded. (AVS definition)

Geometry header: can refer to a point cloud frame geometry header set, which is a parameter set required when point cloud geometry data is decoded.

Attribute header: can refer to a point cloud frame attribute header parameter set, which is a parameter set required when point cloud attribute data is decoded.

Sample number: can refer to a serial number of a particular sample. A serial number of the first sample in a track is 1.

Sample entry: can indicate metadata information related to all samples in a track. For example, a sample entry of a video track typically includes metadata information related to decoder initialization.

Sample group: can be obtained by grouping some samples in a track based on a specific rule.

A point cloud is a set of irregularly distributed discrete points in space that represents a spatial structure and a surface attribute of a three-dimensional (3D) object or scene. Each point in the point cloud carries at least 3D position information, and may further contain color, material, or other attribute information depending on application scenarios. Typically, each point in the point cloud contains a same number of additional attributes.

Point cloud media may be classified by encoding modes into V-PCC point cloud media compressed based on a related video encoding mode, G-PCC point cloud media compressed based on a geometry feature, and AVS-PCC point cloud compression based on the Chinese National AVS. During file encapsulation of a point cloud file, 3D position information is usually referred to as a geometry component of the point cloud file, and attribute information is referred to as an attribute component of the point cloud file. One point cloud file has only one geometry component, but may have one or more attribute components.

The point cloud may flexibly and conveniently represent the spatial structure and the surface attribute of the 3D object or scene. Therefore, it is applied to a wide ranges of application scenarios, including a virtual reality (VR) game, computer-aided design (CAD), a geography information system (GIS), an autonomous navigation system (ANS), a digital cultural heritage, free viewpoint broadcasting, 3D immersive telepresence, 3D reconstruction of biological tissues and organs, and the like.

Point clouds are acquired mainly by the following methods: computer generation, 3D laser scanning, 3D photogrammetry, and the like. A computer may generate point clouds of virtual 3D objects and scenes. A point cloud of a 3D object or scene in the static real-world may be obtained through 3D scanning, and a point cloud including millions of points may be acquired per second. A point cloud of a 3D object or scene in the dynamic real-world may be obtained through 3D photography, and a point cloud including tens of millions of points may be acquired per second. In addition, in the medical field, point clouds of biological tissues and organs may be obtained based on magnetic resonance imaging (MRI), computed tomography (CT), and electromagnetic positioning information. These technologies reduce costs and time for acquiring point cloud data, and improve data precision. With a change of the method for acquiring point cloud data, it is possible to acquire a large amount of point cloud data. With the continuous accumulation of large-scale point cloud data, efficient storage, transmission, release, sharing, and standardization of point cloud data have become the key to point cloud application.

After point cloud media is encoded, an encoded data stream needs to be encapsulated and then transmitted to a user. Accordingly, on a point cloud media player, a point cloud file needs to be decapsulated first and then decoded, and finally a decoded data stream is presented.

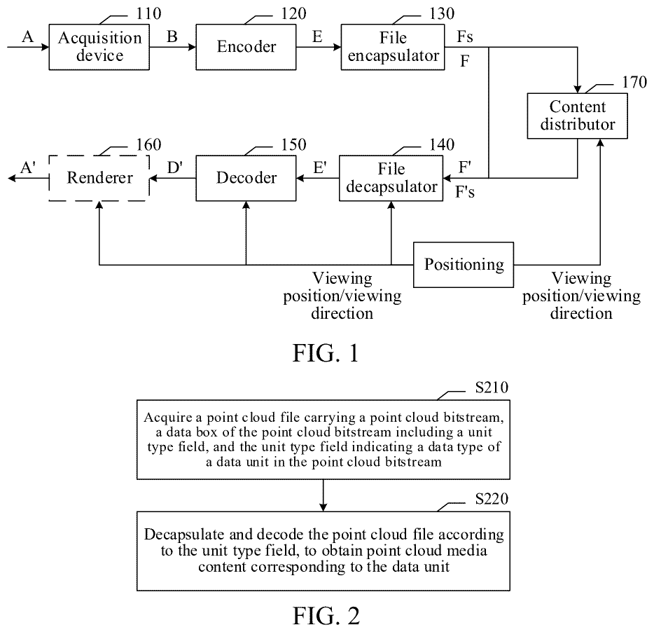

FIG. 1 is a schematic diagram of a system architecture of point cloud media encoding/decoding in an application scenario according to an embodiment of this disclosure.

An acquisition device 110 may perform point cloud data acquisition to capture a visual scene A of the real word. For example, the acquisition device 110 is a group of cameras or a camera device having a plurality of lens and a plurality of sensors. An acquisition result is point cloud source data B. The point cloud source data B is a frame sequence including a large number of point cloud frames. An encoder 120 may encode one or more point cloud frames, to obtain an encoded G-PCC bitstream, which may, in an example, include an encoded geometry bitstream and an encoded attribute bitstream E. A file encapsulator 130 may encapsulate one or more encoded bitstreams based on a specific media container file format, to obtain a media file F for file playback or a series of initialization segments and a media segment Fs for streaming transmission. In some embodiments of this disclosure, the media container file format may be, for example, an ISOBMFF specified in ISO/IEC 14496-11 [ISOBMFF]. The file encapsulator 130 may further encapsulate metadata within the media file F or the media segment Fs.

The media file F outputted by the file encapsulator 130 is the same as a media file F′ inputted into a file decapsulator 140. The file decapsulator may process the media file F′ or a received media fragment F's, to extract an encoded bitstream E′ and parse the metadata. A decoder 150 may decode the G-PCC bitstream into a decoded signal D′ and generate point cloud data based on the decoded signal D′. When applicable, the point cloud data may be rendered and displayed on a screen of a head-mounted display or any other display device by a renderer 160 based on a current viewing position, viewing direction, or viewport determined by various types of sensors (such as a head, position, or eye movement sensor). In addition to being used by the player to access an appropriate portion of decoded point cloud data, the current viewing position or viewing direction may also be configured for decoding optimization. In a viewport-related content distributor 170, the current viewing position and viewing direction are also transported to a policy module. The policy module may be configured to determine a to-be-received track.

In the point cloud media transmission technology, transmission of media resources between a server and a client is usually implemented through a streaming transmission technology. A common media streaming technology includes Dynamic Adaptive Streaming over Hypertext Transfer Protocol (DASH), HTTP Live Streaming (HLS), Smart Media Transport (SMT), and another technology.

The DASH is taken as an example. The DASH is an adaptive bitrate streaming technology that enables high-quality streaming media to be transported over the Internet by using a HTTP network server. In the DASH, content is decomposed into a series of small HTTP-based file segments, each segment includes a small length of playable content, while a total length of the content may be up to several hours (such as a movie or a live sporting event). The content may be made into alternate segments at a plurality of bitrates to provide a plurality of bitrate versions for selection. When media content is played on a DASH client, the client may automatically choose, based on a current network condition, an alternate segment for downloading and playback. The client may choose to play a highest bitrate segment that may be downloaded timely, to avoid playback freezing or rebuffering events. Therefore, the DASH client can adapt well to a changing network condition and provide a high-quality playback experience with fewer occurrences of freezing and rebuffering.

The DASH uses an HTTP network server infrastructure. It allows a device such as an Internet television, a television set-top box, a desktop computer, a smartphone, or a tablet computer to consume multimedia content (such as video, television, and radio) transported over the Internet and to cope with a changing Internet receiving condition.

Technical solutions, such as a point cloud file processing method and apparatus, a computer-readable medium, an electronic device, and a computer program product, that are provided in this disclosure are described in detail below with reference to specific implementations. The technical solutions in the embodiments of this disclosure may be applied to a section such as a server, a player, or an intermediate node of a point cloud media system.

FIG. 2 is a flowchart of operations of a point cloud file processing method according to an embodiment of this disclosure. In the embodiments of this disclosure, a description is made by taking a point cloud file decoding method that is performed by a client device on which a point cloud decoding apparatus is installed as an example. As shown in FIG. 2, the point cloud file decoding method may include operation S210 and operation S220.

S210: Acquire a point cloud file carrying a point cloud bitstream, a data box of the point cloud bitstream including a unit type field, and the unit type field indicating a data type of a data unit in the point cloud bitstream.

S220: Decapsulate and decode the point cloud file according to the unit type field, to obtain point cloud media content corresponding to the data unit.

The point cloud file may be a media file or media segment obtained through encoding and encapsulation shown in FIG. 1, and the media file or media segment carries point cloud media content encapsulated in the form of a point cloud track.

In an embodiment of this disclosure, a data source may encapsulate, according to geometry parameter information, attribute parameter information, and parameter information of a point cloud slice that are included in the point cloud media content, the point cloud media content into a point cloud file including a single point cloud track, or may encapsulate the point cloud media content into a point cloud file including a plurality of point cloud tracks. The point cloud track is a volumetric visual track configured to carry a point cloud bitstream (such as an encoded geometry bitstream or an encoded attribute bitstream), or may be a volumetric visual track carrying both an encoded geometry bitstream and an encoded attribute bitstream.

A data box of the point cloud track may be, for example, a data box based on an ISOBMFF. For specific information about the ISOBMFF, refer to the standard ISO/IEC 14496-12.

The data unit is a basic encapsulation unit obtained by performing content division on a point cloud sample in the point cloud bitstream, and different data unit division methods may be adopted in different encapsulation modes. For example, in a component-based multi-track encapsulation mode, one point cloud sample in the point cloud bitstream may include a plurality of data units such as parameter information, geometry data, and attribute data. For another example, in a slice-based multi-track encapsulation mode, one point cloud sample in the point cloud bitstream may include a plurality of data units such as a geometry header, an attribute header, a geometry slice header, an attribute slice header, geometry data, and attribute data.

The following exemplarily describes a data structure related to point cloud encoding/decoding in the related art of this disclosure.

Table 1 shows a data structure of a compressed point cloud bitstream sequence in the related art of this disclosure.

TABLE 1

Descriptor

```
PCC_sequence ( ) {
  do {
      sequence_header ( )
      geometry_header ( )
      if (attribute_present_flag) {
        attribute_header ( )
      }
      do {
            frame_header ( )
            do {
              geometry_slice ( )
              if (attribute_present_flag) {
                attribute_slice ( )
              }
          } while (next_bits (32) == slice_start_code)
    } while (next_bits (32) == frame_start_code)
  } while (next_bits (32) != pcc_sequence_end_code))
}
```

Table 2 shows a data structure of an attribute header data unit in the related art of this disclosure.

TABLE 2

| | Descriptor |
|---|---|
| attribute_header ( ) { | |
| for (attrIdx = 0; attrIdx < (maxNumAttributesMinus1 + 1); attrIdx ++) { | |
| attributePresentFlag[attrIdx] | u(1) |
| if(attributePresentFlag[attrIdx]) { | |
| attribute_data_num_set_minus1[attrIdx] | ue(v) |
| attribute_info_num_set_minus1[attrIdx] | ue(v) |
| for (i = 0; i < (attribute_info_num_set_minus1[attrIdx]+1); i ++) { | |
| outputBitDepthMinus1[attrIdx][i] | ue (v) |
| if(attrIdx == 0 \|\| attrIdx == 1) { | |
| maxNumOfNeighboursLog2Minus7[attrIdx][i] | u(2) |
| numOflevelOfDetail[attrIdx][i] | ue(v) |
| maxNumOfPredictNeighbours [attrIdx][i] | ue(v) |
| intraLodFlag[attrIdx][i] | u(1) |
| parityBasedLevelCodingEnable[attrIdx][i] | u(1) |
| log2_golomb_group_size[attrIdx][i] | ue(v) |
| } | |
| if (attrIdx = = 0) { | |
| cross_component_Pred [i] | u(1) |
| orderSwitch [i] | u(1) |
| chromaQpOffsetCb [i] | se(v) |
| chromaQpOffsetCr [i] | se(v) |
| colorReorderMode [i] | ue(v) |
| colorGolombNum [i] | ue(v) |
| } | |
| if (attrIdx = = 1) { | |
| nearestPredParam1 [i] | ue(v) |
| nearestPredParam2 [i] | ue(v) |
| axisBias [i] | ue(v) |
| refReorderMode [i] | ue(v) |
| refGolombNum [i] | ue(v) |
| predFixedPointFracBit [i] | ue(v) |
| log2_pred_dist_weight_group_size[i] | ue(v) |
| } | |
| if (attributePresentFlag[0]&&attributePresentFlag[1]){ | |
| crossAttrTypePred [i] | u(1) |
| if (crossAttrTypePred [i]) { | |
| attrEncodeOrder [i] | u(1) |
| crossAttrTypePredParam1 [i] | u(15) |
| crossAttrTypePredParam2 [i] | u(21) |
| } | |
| } | |
| transform[attrIdx][i] | ue(2) |
| If(transform [attrIdx][i]== 1) { | |
| kFracBits[attrIdx][i] | ue(v) |
| } | |
| if (transform[attrIdx][i] && | |
| (attributePresentFlag[0]\|\|attributePresentFlag[1])) { | |
| attrTransformQpDelta[attrIdx][i] | ue(v) |
| transformSegmentSize[ attrIdx ][i] | ue(v) |
| maxTransNum[ attrIdx ][i] | ue(v) |
| log2maxNumofCoeffMinus8[ attrIdx ][i] | ue(v) |
| QpOffsetDC[ attrIdx ][i] | se(v) |
| QpOffsetAC[ attrIdx ][i] | se(v) |
| transResLayer[ attrIdx ][i] | u(1) |
| if ( attributePresentFlag[0]) { | |
| chromaQpOffsetDC [i] | se(v) |
| chromaQpOffsetAC [i] | se(v) |
| colorInitPredTransRatio [i] | se(v) |
| colorQPAdjustFlag [i] | u(1) |
| if (colorQPAdjustFlag [i]) { | |
| colorQPAdjustScalar [i] | ue(v) |
| } | |
| } | |
| if ( attributePresentFlag[1]) { | |
| RefGroupPred [i] | u(1) |
| refInitPredTransRatio [i] | ue(v) |
| } | |
| log2coeffLengthControlMinus8[ attrIdx ][i] | ue(v) |
| } | |
| }// for(i=0;i< (attribute_info_num_set_minus1[attrIdx]+1) | |
| } | |
| } | |
| byte_alignment( ) | |
| } | |

Table 3 shows a data structure of an attribute slice data unit in the related art of this disclosure.

TABLE 3

Descriptor

```
attribute_slice_( ) {
  attribute_slice_header( )
  general_attribute_data_bitstream( )
}
```

Table 4 shows a data structure of a general attribute data bitstream in the related art of this disclosure.

TABLE 4

| | Descriptor |
|---|---|
| general_attribute_data_bitstream( ) { | |
| for (attrIdx = 0; attrIdx < (maxNumAttributesMinus1 + 1);attrIdx ++ ){ | |
| If (attributePresentFlag[attrIdx]) { | |
| for(attr= 0;attr<(attribute_data_num_set_minus1[attrIdx] + 1);attr | |
| ++){ | |
| attributeID[attrIdx][ attr] | ue(v) |
| if(attrIdx==0) | |
| attribute_data_color( ) | |
| else | |
| attribute_data_reflectance( ) | |
| byte_alignment( ) | |
| } | |
| } | |
| } | |

The attribute information flag bit attributeID[attrIdx][attr] is an unsigned integer. It is specified that an attr^{th} piece of data of an attribute determined by the attribute index attrIdx uses an (attributeID[attrIdx][attr])^{th} piece of attribute information determined by the attribute index attrIdx, which is a number between 0 to attribute_info_num_set_minus1[attrIdx]. When the syntactic element does not exist in the bitstream, a value of the syntactic element is zero by default.

In the related art of this disclosure, for the data structure of the point cloud bitstream shown in the above table, one point cloud slice includes all attribute data. That is, when a plurality of groups of attribute data exist, such as a color and a reflectance, the color and the reflectance may be considered to belong to a same point cloud slice. When multi-track encapsulation is performed on the point cloud file, different attribute data is allowed to be respectively encapsulated within different attribute component tracks, which is contradictory to the data structure of the related point cloud bitstream.

For the problem existing in the related art, in the embodiments of this disclosure, the unit type field is defined in the data box of the point cloud bitstream, and the data type of the data unit in the point cloud bitstream may be indicated based on the unit type field. In this way, some data units that are in the point cloud file and that are of a specified data type may be selectively decoded according to the data type indicated by the unit type field. Therefore, data access flexibility of the point cloud file can be optimized.

In an embodiment of this disclosure, the point cloud sample in the point cloud bitstream is defined as follows:

```
aligned(8) class AVSPCCSample ( ){
  unsigned int PCCLength = sample_size; //Size of Sample
for (i=0; i< PCCLength; ) // to end of the sample
  {
      unsigned int(8) avs_pcc_unit_type;
    unsigned int(32) avs_pcc_unit_length;
    bit(avs_pcc_unit_length*8) avs_pcc_unit;
      i += (1+4)+ avs_pcc_unit_length;
  }
}
```

One point cloud sample may include one or more data units.
avs_pcc_unit_length indicates a number of bytes of a corresponding data unit.
avs_pcc_unit indicates the corresponding data unit.

A value of the unit type field avs_pcc_unit_type is defined in Table 5.

TABLE 5

| avs_pcc_unit_type | Meanings |
|---|---|
| 0 | Point cloud sequence header sequence_header( ) |
| 1 | Point cloud geometry header geometry_header( ) |
| 2 | Point cloud attribute header attribute_header( ) |
| 3 | Point cloud frame header frame_header( ) |
| 4 | Point cloud geometry slice geometry_slice( ) |
| 5 | Point cloud attribute slice attribute_slice( ) |
| 6 | Point cloud color data attribute_slice_color( ) |
| 7 | Point cloud reflectance data attribute_slice_ref( ) |

In an embodiment of this disclosure, the data type of the data unit includes a point cloud attribute slice of an unspecified attribute type or a point cloud attribute slice of a specified attribute type.

The point cloud attribute slice of the unspecified attribute type may be, for example, the point cloud attribute slice attribute_slice of general attribute data shown in Table 5, and the point cloud attribute slice of the specified attribute type may be, for example, the point cloud color data attribute_slice_color or point cloud reflectance data attribute_slice_ref shown in Table 5.

Data structures of the point cloud color data attribute_slice_color and the point cloud reflectance data attribute_slice_ref are respectively shown in Table 6 and Table 7.

TABLE 6

```
attribute_slice_color( ) {
    attribute_slice_header( )
  attribute_data_color( )
}
```

TABLE 7

```
attribute_slice_ref( ) {
    attribute_slice_header( )
  attribute_data_reflectance( )
}
```

In the embodiments of this disclosure, the unit type field indicates that a data type of one data unit is the point cloud attribute slice of the unspecified attribute type or the point cloud attribute slice of the specified attribute type. In this way, during file decoding and presentation, attribute data of all attribute types of a point cloud can be separately accessed, or attribute data of the specified attribute type can be separately accessed.

In an embodiment of this disclosure, the data unit in the point cloud bitstream may be encapsulated in a type-length-value (TLV) bytestream format, that is, one data unit avs_pcc_unit is correspondingly defined as one tlv unit. The TLV bytestream format refers to a structure formed by a data type, a data length, and a data value. For specific information about the TLV bytestream format, refer to the standard ISO/IEC 23090-9.

Table 8 shows a syntactic structure of a data unit encapsulated based on the TLV bytestream format according to an embodiment of this disclosure.

TABLE 8

| | Descriptor |
|---|---|
| tlv_encapsulation( ) { | |
| tlv_type | u(8) |
| tlv_num_payload_bytes | u(32) |
| for( = 0; < tlv_num_payload_bytes; ++) | |
| tlv_payload_byte[ ] | u(8) |
| } | |

tlv_type corresponds to the unit type field avs_pcc_unit_type in the foregoing point cloud sample definition, tlv_num_payload_bytes corresponds to the number of bytes avs_pcc_unit_length of the data unit in the foregoing point cloud sample definition, and a set of tlv_payload_byte is a set of the data units avs_pcc_unit.

For semantic descriptions of different values of the unit type field in the data unit, refer to the meanings in Table 5.

In an embodiment of this disclosure, the point cloud file includes one or more attribute component tracks obtained by encapsulating a plurality of groups of attribute data.

When the plurality of groups of attribute data is encapsulated within one attribute component track, the unit type field indicates that a data type of a data unit in the attribute component track is a point cloud attribute header or the point cloud attribute slice of the unspecified attribute type. For example, in the embodiments of this disclosure, N groups of attribute data may be encapsulated within one attribute component track. In this case, the attribute component track may include data units of two data types: the point cloud attribute header attribute_header, or the point cloud attribute slice attribute_slice of the unspecified attribute type.

When the plurality of groups of attribute data is encapsulated within a plurality of attribute component tracks, the unit type field indicates that a data type of a data unit in the attribute component track is a point cloud attribute header or the point cloud attribute slice of the specified attribute type. For example, in the embodiments of this disclosure, N groups of attribute data may be encapsulated within a plurality of attribute component tracks, each attribute component track may include M groups of attribute data, and M is an integer greater than or equal to 1 and less than N. That is, one attribute component track includes a part of attribute data of the specified attribute type. Two attribute types, namely, a color and a reflectance, are taken as an example. One attribute component track may include data units of two data types: the point cloud attribute header attribute_header, or the point cloud color data attribute_slice_color. Another attribute component track may include data units of two data types: the point cloud attribute header attribute_header, or the point cloud reflectance data attribute slice ref.

In the embodiments of this disclosure, in a case that different point cloud track encapsulation modes are adopted, the unit type field indicates whether a data type of a data unit is the point cloud attribute header or the point cloud attribute slice, and indicates whether the point cloud attribute slice is of the specified attribute type, whereby selection flexibility in data access can be further optimized.

In an embodiment of this disclosure, when the data type of the data unit is the point cloud attribute slice of the specified attribute type, a data structure of the point cloud attribute slice includes a slice data type field, which indicates the specified attribute type.

In an embodiment of this disclosure, when the data type of the data unit is the point cloud attribute slice of the specified attribute type, the data unit includes at least one of a point cloud attribute slice header or a point cloud attribute data bitstream.

A data structure of the point cloud attribute slice header includes the slice data type field and a slice identifier field. The slice identifier field indicates an identifier of the point cloud attribute slice.

A data structure of the point cloud attribute data bitstream includes the slice data type field and a parameter set flag field. The parameter set flag field indicates a parameter set used when the point cloud attribute data bitstream is decoded.

Table 9 shows a data structure of the point cloud attribute slice header attribute slice_header according to an embodiment of this disclosure.

TABLE 9

| | Descriptor |
|---|---|
| attribute_slice_header( ) { | |
| slice_id | ue(v) |
| slice_data_type | ue(v) |
| if(slice_data_type == 1) | |
| reflQPoffset | se(v) |
| if(slice_data_type == 2) | |
| para_set_index_color | ue(v) |
| para_set_index ref | ue(v) |
| } | |
| else | |
| para_set_index | ue(v) |
| byte_alignment( ) | |
| } | |

Table 10 shows a data structure of the point cloud attribute slice data bitstream general_attribute_data_bitstream according to an embodiment of this disclosure.

TABLE 10

Descriptor

```
general_attribute_data_bitstream( ) {
  if (slice_data_type == 0) {
        attribute_data_color( )
        byte_alignment( )
    }
    if (slice_data_type == 1) {
        attribute_data_reflectance( )
        byte_alignment( )
    }
    if(slice_data_type == 2){
        attribute_data_color_ref( )
        byte_alignment( )
      }
}
```

slice id indicates the identifier of the point cloud attribute slice.

reflQPoffset is configured for controlling a reflectance attribute quantization parameter, and a value range of reflQPoffset may be, for example, −32 to 32.

slice_data_type indicates a data type included in a current point cloud attribute slice. For example, a value of 0 indicates that the current point cloud attribute slice includes the color data attribute_data_color; a value of 1 indicates that the current point cloud attribute slice includes the reflectance data attribute_data_reflectance; and a value of 2 indicates that the current point cloud attribute slice includes the color and reflectance hybrid data attribute_data_color_ref.

para_set_index_color indicates a serial number of a parameter set used when the color data in the point cloud attribute slice including the color and reflectance hybrid data is decoded, and a value range of the field may be, for example, 0 to attribute_info_num_set_minus1[0].

para_set_index_ref indicates a serial number of a parameter set used when the reflectance data in the point cloud attribute slice including the color and reflectance hybrid data is decoded, and a value range of the field may be, for example, 0 to attribute info_num_set_minus1[1].

para_set_index indicates a serial number of a parameter set used when the current point cloud attribute slice is decoded. If the current point cloud attribute slice is the color data, a value range of the field may be 0 to attribute_info_num_set_minus1[0]; and if the current point cloud attribute slice is the reflectance data, a value range of the field may be 0 to attribute_info_num_set_minus1[1].

In an embodiment of this disclosure, the point cloud file further includes one geometry component track obtained by encapsulating geometry data. The unit type field indicates that a data type of a data unit in the geometry component track is at least one of a point cloud sequence header sequence_header, a point cloud geometry header geometry_header, a point cloud frame header frame_header, or a point cloud geometry slice geometry_slice.

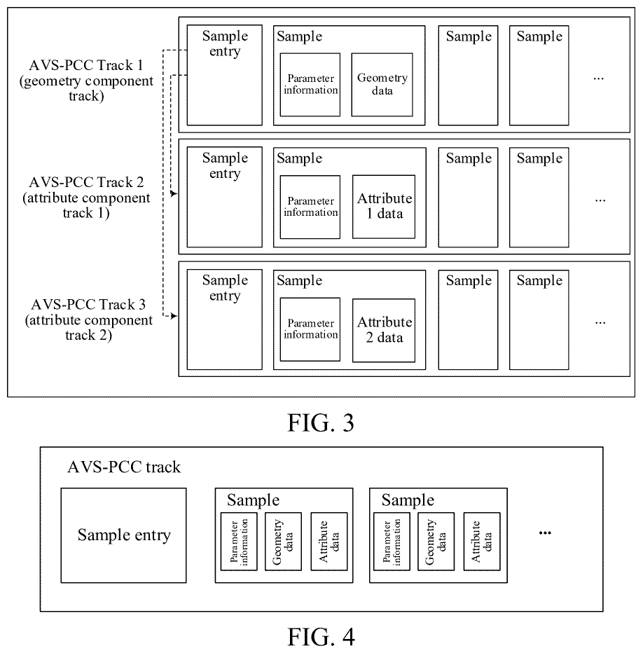

FIG. 3 is a diagram of a point cloud file obtained through multi-track encapsulation based on a component type according to an embodiment of this disclosure.

As shown in FIG. 3, the point cloud file includes three point cloud tracks obtained through encapsulation based on a component type. AVS-PCC Track 1 is a geometry component track, AVS-PCC Track 2 is an attribute component track 1 corresponding to one attribute type (such as a color attribute), and AVS-PCC Track 3 is an attribute component track 2 corresponding to another attribute type (such as a reflectance attribute). In some other implementations, AVS-PCC Track 2 and AVS-PCC Track 3 may be respectively attribute component tracks corresponding to a plurality of attribute types. For example, AVS-PCC Track 2 includes attribute data of two different attribute types, and AVS-PCC Track 3 includes attribute data of another two different types.

In an embodiment of this disclosure, a plurality of groups of attribute data and geometry data may be encapsulated within a same point cloud track, that is, point cloud file encapsulation may be performed based on a single-rack mode.

FIG. 4 is a diagram of a point cloud file obtained through single-track encapsulation according to an embodiment of this disclosure.

As shown in FIG. 4, the point cloud file includes only one point cloud track, that is, an AVS-PCC track. A point cloud sample in the point cloud track may include data units such as parameter information, geometry data, and attribute data.

In an embodiment of this disclosure, the point cloud file includes a point cloud slice track obtained by encapsulating attribute data of a plurality of point cloud slices.

When all the attribute data of the plurality of point cloud slices is encapsulated within one point cloud slice track, the unit type field indicates that a data type of a data unit in the point cloud slice track is the point cloud attribute slice of the unspecified attribute type. For example, data corresponding to J point cloud slices is encapsulated within one point cloud slice track (it is assumed that a point cloud frame includes K point cloud slices, and J<K), and each point cloud slice track includes all N groups of attribute component data (namely, all the attribute data) corresponding to the corresponding point cloud slice.

When part of the attribute data of the plurality of point cloud slices is encapsulated within one point cloud slice track, the unit type field indicates that a data type of a data unit in the point cloud slice track is the point cloud attribute slice of the specified attribute type. For example, data corresponding to J point cloud slices is encapsulated within one point cloud slice track (it is assumed that a point cloud frame includes K point cloud slices, and J<K), and each point cloud slice track includes only M groups of attribute component data (1<=M<N, namely, part of the attribute data) corresponding to the corresponding point cloud slice.

In an embodiment of this disclosure, the point cloud file further includes a point cloud slice track obtained by encapsulating geometry data of a plurality of point cloud slices; and the unit type field indicates that a data type of a data unit in the point cloud slice track is a point cloud geometry slice.

In an embodiment of this disclosure, the point cloud file further includes a point cloud slice base track obtained by encapsulating parameter information of a plurality of point cloud slices; and the unit type field indicates that a data type of a data unit in the point cloud slice base track is at least one of a point cloud sequence header, a point cloud geometry header, a point cloud attribute header, or a point cloud frame header.

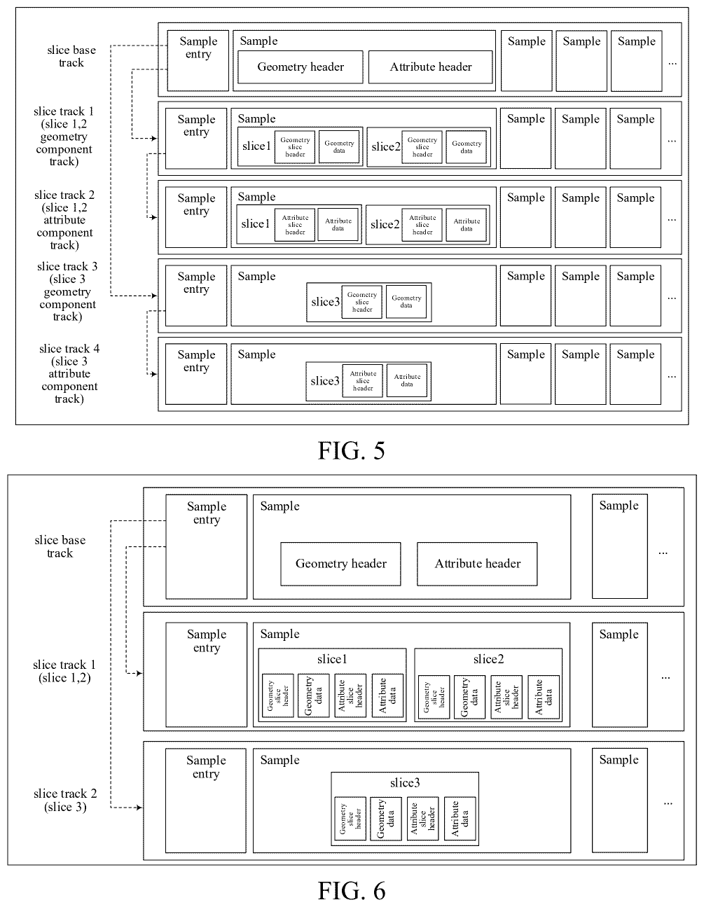

FIG. 5 is a diagram of a point cloud file obtained through multi-track encapsulation based on a point cloud slice according to an embodiment of this disclosure.

As shown in FIG. 5, in a mode of performing multi-track encapsulation based on a point cloud slice, the point cloud file includes a point cloud slice base track, a geometry component track associated with the point cloud slice base track, and an attribute component track associated with the geometry component track.

For example, the point cloud file corresponds to three point cloud slices, which are slice1, slice2, and slice3, respectively.

A sample in the point cloud slice base track includes a geometry header and an attribute header.

slice track1 is a geometry component track corresponding to the point cloud slices slice1 and slice2, and a sample in the track includes geometry slice headers and geometry data of the point cloud slices slice1 and slice2.

slice track2 is an attribute component track corresponding to the point cloud slices slice1 and slice2, and a sample in the track includes attribute slice headers and attribute data of the point cloud slices slice1 and slice2.

slice track3 is a geometry component track corresponding to the point cloud slice slice3, and a sample in the track includes a geometry slice header and geometry data of the point cloud slice slice3.

slice track4 is an attribute component track corresponding to the point cloud slice slice4, and a sample in the track includes an attribute slice header and attribute data of the point cloud slice slice4.

In an embodiment of this disclosure, the attribute data of the plurality of point cloud slices and the geometry data of the plurality of point cloud slices may be encapsulated within a same point cloud slice track. For example, data corresponding to J point cloud slices is encapsulated within one point cloud slice track (it is assumed that a point cloud frame includes K point cloud slices, and J<K), and the point cloud slice track includes geometry data and attribute data that correspond to each point cloud slice.

FIG. 6 is a diagram of a point cloud file obtained by simultaneously encapsulating geometry data and attribute data of a point cloud slice within a single track according to an embodiment of this disclosure.

As shown in FIG. 6, in a mode of simultaneously encapsulating geometry data and attribute data of a point cloud slice, the point cloud file includes one point cloud slice base track, and one or more point cloud slice tracks associated with the point cloud slice base track.

For example, the point cloud file corresponds to three point cloud slices, which are slice1, slice2, and slice3, respectively.

A sample in the point cloud slice base track includes a geometry header and an attribute header.

slice track1 is a point cloud slice track corresponding to the point cloud slices slice1 and slice2, and a sample in the track includes geometry slice headers, geometry data, attribute slice headers, and attribute data of the point cloud slices slice1 and slice2.

slice track2 is a point cloud slice track corresponding to the point cloud slice slice3, and a sample in the track include a geometry slice header, geometry data, an attribute slice header, and attribute data of the point cloud slice slice3.

In an embodiment of this disclosure, the point cloud file includes one or more point cloud tracks obtained by encapsulating the point cloud bitstream, each point cloud track includes a plurality of point cloud samples, and each point cloud sample includes one or more sub-samples; and the data box of the sub-sample includes a type flag field, and the type flag field indicates a data type of the sub-sample.

The sub-samples are data encapsulation units in the point cloud sample. Different types of sub-samples may be obtained by dividing the point cloud sample based on different division manners. For example, sub-samples having different data capacities may be obtained by dividing the point cloud sample based on different dimensions such as data units, spatial blocks, or point cloud sub-frames.

In an embodiment of this disclosure, if a value of the type flag field is a preset first value (such as 0), the data type of the sub-sample is the data type indicated by the unit type field; or if a value of the type flag field is a second value (such as an available value different from 0) different from the first value, the data type of the sub-sample is not the data type indicated by the unit type field.

In an embodiment of this disclosure, if the value of the type field is the first value, and the data type indicated by the unit type field is a type related to a point cloud slice, the data box of the sub-sample further includes a slice identifier field, and the slice identifier field indicates an identifier of a point cloud slice corresponding to the sub-sample.

Based on the sample definition in the embodiments of this disclosure, a data structure of the sub-sample may be correspondingly defined.

Each point cloud sample may be divided into one or more point cloud sub-samples, which is denoted as SubSampleInformationBox during encapsulation of point cloud data, the sub-sample is defined according to a value of a type flag field (flags) of sub-sample information data, and the type flag field indicates a data type of the sub-sample information in a data box.

When a value of the type flag field is 0, it indicates that the sub-sample is a sub-sample based on a point cloud data type. That is, one sub-sample includes only one data type defined by avs_pcc_unit_type. The type flag field may further have another reserved flag value.

A field codec_specific_parameters in SubsampleInformationBox is defined as follows:

```
if(flags == 0){
  unsigned int(8) avs_pcc_unit_type;
  if(avs_pcc_unit_type >=4)
    unsigned int(24) slice_id;
  else
    bit(24) reserved = 0;
}
```

avs_pcc_unit_type indicates a data type of a point cloud included in the sub-sample, and a value meaning and a value range are the same as those defined for data in the sample.

In an embodiment of this disclosure, when the data unit in the point cloud bitstream includes a point cloud attribute slice of a specified attribute type, the data box of the point cloud bitstream further includes: a set attribute flag field default_attr_index, indicating whether a parameter set referenced when the point cloud attribute slice is decoded is a target parameter set in a point cloud attribute header. The target parameter set may be a pre-specified parameter set in a point cloud header.

In an embodiment of this disclosure, the point cloud attribute header of the point cloud bitstream includes one or more parameter sets corresponding to the specified attribute type. The target parameter set is a unique parameter set that is in the point cloud attribute header and that corresponds to the specified attribute type, or is a parameter set that is in the point cloud attribute header and that is in a specified position order corresponding to the specified attribute type. For example, if a current point cloud attribute slice is point cloud color data, the target parameter set may be a unique parameter set that is in the point cloud attribute header and that corresponds to a color attribute, or may be the first parameter set that is in the point cloud attribute header and that corresponds to the color attribute.

In an embodiment of this disclosure, when the data unit in the point cloud bitstream includes a point cloud attribute slice of a specified attribute type, the data box of the point cloud bitstream further includes: a parameter set flag field attr_para_set_index, indicating a position order of a parameter set referenced when the point cloud attribute slice is decoded in the point cloud attribute header.

In an embodiment of this disclosure, the position order is a set arrangement order in a plurality of parameter sets corresponding to the specified attribute type.

In an embodiment of this disclosure, when the data unit in the point cloud bitstream includes a point cloud attribute slice of a specified attribute type, the data box of the point cloud bitstream further includes: a dynamic attribute flag field dynamic_attr_index, indicating whether a position order of a parameter set referenced when the point cloud attribute slice is decoded in the point cloud attribute header is a fixed value.

In an embodiment of this disclosure, when the data unit in the point cloud bitstream includes a point cloud attribute slice of a specified attribute type, the data box of the point cloud bitstream further includes at least one of the following fields:
an attribute number field attr_num, indicating a number of types of point cloud attribute slices included in the point cloud bitstream, where for example, if the point cloud bitstream includes two attribute types, namely, a color and a reflectance, a value of the attribute number field attr_num is 2;
an attribute type field attr_type, indicating an attribute type of the point cloud attribute slice included in the point cloud bitstream, where for example, when a value of the field is 0, the field indicates a color attribute; or when a value of the field is 1, the field indicates a reflectance attribute; or
an attribute identifier field attr_id, indicating an identifier of the point cloud attribute slice included in the point cloud bitstream.

In an embodiment of this disclosure, an attribute parameter set information data box in the point cloud bitstream may be defined as follows:

```
aligned(8) class AVSPCCAttrParaSetInfoBox
  unsigned int(8) attr_num;
  for(i=0; i<attr_num; i++){
      unsigned int(4) attr_type;
      unsigned int(1) default_attr_index;
    unsigned int(1) dynamic_attr_index;
    bit(2) reserved = 0;
    unsigned int(16) attr_id;
    if(default_attr_index == 0){
        unsigned int(8) attr_para_set_index;
    }
  }
}
```

attr_num indicates a number of attribute components included in the track.

attr_type indicates a type of the attribute component included in the track. When a value of the field is 0, it indicates a color attribute; or when a value of the field is 1, it indicates a reflectance attribute.

attr_id indicates an identifier of attribute component data.

When a value of default_attr_index is 1, it indicates that a parameter set referenced when current attribute component data is decoded is a first group of parameter sets of the type attribute in the attribute header; or when a value of default_attr_index is 0, it indicates that a parameter set referenced when current attribute component data is decoded is not a first group of parameter sets of the type attribute in the attribute header.

In another implementation, a meaning of the field may alternatively be defined as follows:
when a value of default_attr_index is 1, it indicates that a parameter set referenced when current attribute component data is decoded is a unique parameter set of the type attribute in the attribute header; or when a value of default_attr_index is 0, it indicates that a parameter set referenced when current attribute component data is decoded is not a unique parameter set of the type attribute in the attribute header.

attr_para_set_index indicates an order of the parameter set referenced when the current attribute component data is decoded in the attribute header. (In another implementation, it may be further defined that the order is an order under a corresponding attribute type.)

When a value of dynamic_attr_index is 0, it indicates that the order of the parameter set referenced when the current attribute component data is decoded in the attribute header (under the type attribute) is kept unchanged. When a value of dynamic_attr_index is 1, it indicates that the order of the parameter set referenced when the current attribute component data is decoded in the attribute header (under the type attribute) changes.

In an embodiment of this disclosure, the point cloud bitstream includes a parameter header sample group including a plurality of parameter header samples, and each parameter header sample includes a point cloud geometry header or a point cloud attribute header; and when the data unit in the point cloud bitstream includes a point cloud attribute slice of a specified attribute type, a data box of the parameter header sample group includes: an attribute identifier field, indicating an identifier of a point cloud attribute slice; and a parameter set flag field, indicating a position order of a parameter set referenced when the point cloud attribute slice is decoded in the point cloud attribute header.

In an embodiment of this disclosure, the position order is a set arrangement order in a plurality of parameter sets corresponding to the specified attribute type.

In an embodiment of this disclosure, the data box of the parameter header sample group further includes:
a parameter set information flag field, indicating whether the parameter set referenced when the point cloud attribute slice is decoded is a target parameter set in the point cloud attribute header.

In an embodiment of this disclosure, if a value of a parameter set information flag field of any point cloud sample in the point cloud bitstream is a preset value, a value of a parameter set information flag field of a synchronization sample in the point cloud bitstream is the preset value. The parameter set information flag field whose value is the preset value indicates that the parameter set referenced when the point cloud sample is decoded in the point cloud attribute header is the target parameter set, and the synchronization sample is a sample that can be directly decoded when the point cloud file is decoded.

In an embodiment of this disclosure, a data box of the parameter header sample group may be defined as follows:

```
  aligned(8) class AvsPccHeaderInfoEntry( ) extends
VolumetricVisualSampleGroupEntry (‘appi’) {
    unsigned int(1) attr_para_set_info_flag;
    if(attr_para_set_info_flag){
      for(int i=0; i<attr_num; i++)
        unsigned int(16) attr_id;
        unsigned int(16) attr_para_set_index;
    }
  }
```

attr_id indicates an identifier of attribute component data.

attr_para_set_index indicates an order of a parameter set referenced when corresponding attribute component data (namely, attribute component data corresponding to the corresponding attr_id) is decoded in the attribute header (under the type attribute). (In another implementation, it may be further defined that the order is an order under a corresponding attribute type.)

The field attr_num is a value of a corresponding field in an attribute component track.

Meanwhile, if a value of attr_para_set_info_flag of a sample in the samples of the point cloud bitstream is 1, a value of attr_para_set_info_flag of any synchronization sample of the track needs to be 1.

In an embodiment of this disclosure, when the data unit in the point cloud bitstream includes a point cloud attribute slice of a specified attribute type, a data structure of the point cloud attribute slice includes: a parameter set flag field, indicating a parameter set that is referenced when the point cloud attribute slice is decoded and that corresponds to the specified attribute type.

A color attribute and a reflectance attribute are taken as an example. In the embodiments of this disclosure, data structures of point cloud color data attribute_slice_color and point cloud reflectance data attribute_slice_ref are respectively shown in Table 11 and Table 12.

TABLE 11

```
attribute_slice_color( ) {
  attribute_slice_header( )
  unsigned int(16) para_set_index_color
  attribute_data_color( )
}
```

TABLE 12

```
attribute_slice_ref( ) {
  attribute_slice_header( )
  unsigned int(16) para_set_index_ref
  attribute_data_reflectance( )
}
```

The foregoing embodiments describe a processing method implemented on a decoder of a point cloud file according to this disclosure.

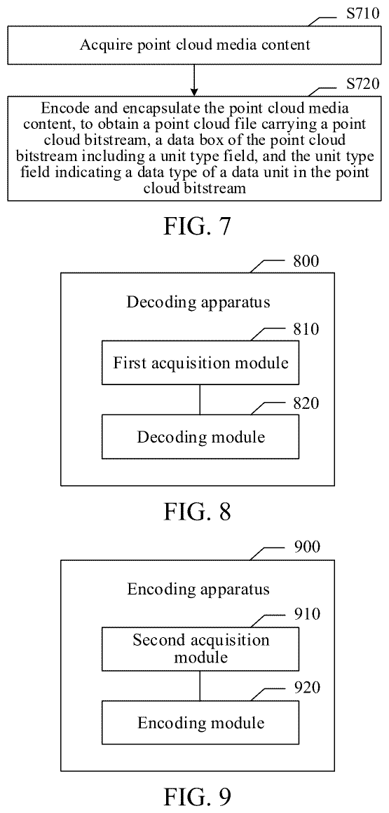

FIG. 7 is a flowchart of operations of a point cloud file processing method according to an embodiment of this disclosure. In the embodiments of this disclosure, a description is made by taking a point cloud file encoding method that is performed by a client device on which a point cloud encoding apparatus is installed as an example. As shown in FIG. 7, the point cloud file encoding method includes operation S710 and operation S720.

S710: Acquire point cloud media content.

S720: Encode and encapsulate the point cloud media content, to obtain a point cloud file carrying a point cloud bitstream, a data box of the point cloud bitstream including a unit type field, and the unit type field indicating a data type of a data unit in the point cloud bitstream.

According to the embodiments of this disclosure, the point cloud file processing method is implemented on an encoder. A specific implementation of the method corresponds to the foregoing embodiments of the decoder, and details are not described herein again.

The following exemplarily describes, with reference to a specific application scenario, a process of transmitting point cloud data between a server of the encoder and a client of the decoder over a network according to an embodiment of this disclosure.

The point cloud file encapsulation method proposed in this disclosure includes the following implementation operations.
1. The server acquires a point cloud bitstream, the point cloud bitstream including geometry data and N groups of attribute data (N>0)
2. The server encapsulates the point cloud bitstream within one or more file tracks in one of the following modes:
1) The server performs encapsulation based on a component type, that is, encapsulates the geometry data within one point cloud geometry component track, and encapsulates the N groups of attribute data within one attribute component track. A sample in the geometry component track includes an avs point cloud unit, and a value of avs_pcc_unit_type of the point cloud unit can only be 0 to 1, or 3 to 4. A sample in the attribute component track includes an avs point cloud unit, and a value of avs_pcc_unit_type of the point cloud unit can only be 2 or 5.
2) The server performs encapsulation based on a component type, that is, encapsulates the geometry data within one point cloud geometry component track, and encapsulates the N groups of attribute data within M attribute component tracks (1<=M<N). A sample in the geometry component track includes an avs point cloud unit, and a value of avs_pcc_unit_type of the point cloud unit can only be 0 to 1, or 3 to 4. A sample in the attribute component track includes an avs point cloud unit, and a value of avs_pcc_unit_type of the point cloud unit can only be 2 or 6 to 7.
3) The server performs encapsulation based on a point cloud slice, that is, encapsulates data corresponding to J point cloud slices within one point cloud slice track (it is assumed that a point cloud frame includes K point cloud slices, and J<K), each point cloud slice track including only geometry component data or N groups of attribute component data corresponding to the corresponding point cloud slice. A sample in the point cloud slice base track includes an avs point cloud unit, and a value of avs_pcc_unit_type of the point cloud unit can only be 0 to 3. If the point cloud slice track corresponds to a geometry component, the sample includes the avs point cloud unit, and the value of avs_pcc_unit_type of the point cloud unit can only be 4. If the point cloud slice track corresponds to an attribute component, the sample includes the avs point cloud unit, and the value of avs_pcc_unit_type of the point cloud unit can only be 5.
4) The server performs encapsulation based on a point cloud slice, that is, encapsulates data corresponding to J point cloud slices within one point cloud slice track (it is assumed that a point cloud frame includes K point cloud slices, and J<K), each point cloud slice track including only geometry component data or M groups of attribute component data (1<=M<N) corresponding to the corresponding point cloud slice. A sample in the point cloud slice base track includes an avs point cloud unit, and a value of avs_pcc_unit_type of the point cloud unit can only be 0 to 3. If the point cloud slice track corresponds to a geometry component, the sample includes the avs point cloud unit, and the value of avs_pcc_unit_type of the point cloud unit can only be 4. If the point cloud slice track corresponds to an attribute component, the sample includes the avs point cloud unit, and the value of avs_pcc_unit_type of the point cloud unit can only be 6 or 7.
5) The server performs encapsulation based on a point cloud slice, that is, encapsulates data corresponding to J point cloud slices within one point cloud slice track (it is assumed that a point cloud frame includes K point cloud slices, and J<K), the point cloud slice track including geometry and attribute data corresponding to each point cloud slice. A sample in the point cloud slice base track includes an avs point cloud unit, and a value of avs_pcc_unit_type of the point cloud unit can only be 0 to 3. A sample in the point cloud slice track includes an avs point cloud unit, and a value of avs_pcc_unit_type of the point cloud unit can only be 4 or 5, or 4 or 6 to 7.
6) The server performs single-track encapsulation, that is, encapsulates the point cloud bitstream within one file track. A sample in the point cloud track includes an avs point cloud unit, and a value of avs_pcc_unit_type of the point cloud unit can only be 0 to 4, 5, or 0 to 4 and 6 to 7.
3. When adopting two different encapsulation modes, the server adds corresponding metadata information to indicate necessary information required for decoding the file track, including:
1) defining sample and sub-sample information;
2) defining a parameter set information data box; and
3) modifying metadata information indicated by a parameter header sample group.
4. According to a transmission manner between the server and the client,
1) the server directly transmits a point cloud file F to the client; or
2) the server slices a point cloud file F to obtain an Fs set, each Fs slice including corresponding slices of X file tracks, and transmits file track data required by a user in the corresponding slice to the user according to the requirements of the user.
5. According to a transmission manner between the server and the client,
1) the client receives a complete point cloud file F1, when decapsulating, decoding, and presenting the point cloud file, the client selects all or part of tracks in F1 for decoding and presentation based on user device performance and requirements for a presentation effect, as well as corresponding metadata information in the file; or
2) the client receives the sliced file Fs, the client decapsulates and decodes the received file slice and finally presents point cloud content.

In the foregoing decoding process, the client may selectively extract, according to information in the samples and the sub-samples, the corresponding point cloud slice and parameter header for decoding. For parameter information required for decoding the attribute data, corresponding parameters may be correspondingly found according to an order of a parameter set corresponding to the attribute data in the attribute header.

It can be known based on the descriptions of the foregoing application scenarios that according to the solution provided in the embodiment of this disclosure, the point cloud bitstream can be flexibly encapsulated within one or more file tracks, and partial access to samples in the track is supported.

The operations of the method of this disclosure are described in a specific order in the accompanying drawings. However, this does not request or imply that the operations are performed according to the specific order, or all shown operations are necessarily performed to implement a desired result. Additionally or alternatively, some operations may be omitted, a plurality of operations may be combined into one operation for execution, and/or one operation may be decomposed into a plurality of operations for execution.

Apparatus embodiments of this disclosure are described below, which may be configured for performing the point cloud file processing method in the foregoing embodiment of this disclosure. FIG. 8 is a structural block diagram of a point cloud file processing apparatus on a decoder according to an embodiment of this disclosure. As shown in FIG. 8, a point cloud file decoding apparatus 800 may include:
a first acquisition module 810, configured to acquire a point cloud file carrying a point cloud bitstream, a data box of the point cloud bitstream including a unit type field, and the unit type field indicating a data type of a data unit in the point cloud bitstream; and
a decoding module 820, configured to decapsulate and decode the point cloud file according to the unit type field, to obtain point cloud media content corresponding to the data unit.

FIG. 9 is a structural block diagram of a point cloud file processing apparatus on an encoder according to an embodiment of this disclosure. As shown in FIG. 9, a point cloud file encoding apparatus 900 may include:
a second acquisition module 910, configured to acquire point cloud media content; and
an encoding module 920, configured to encode and encapsulate the point cloud media content, to obtain a point cloud file carrying a point cloud bitstream, a data box of the point cloud bitstream including a unit type field, and the unit type field indicating a data type of a data unit in the point cloud bitstream.

Specific details of the point cloud file processing apparatus provided in the embodiments of this disclosure are described in detail in the corresponding method embodiments and are not be described herein again.

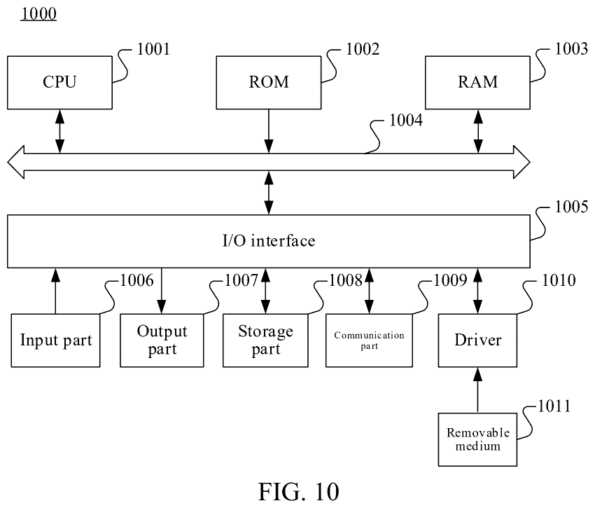

FIG. 10 is a structural block diagram of a computer system for implementing an electronic device according to an embodiment of this disclosure.

A computer system 1000 of an electronic device shown in FIG. 10 is merely an example, and does not constitute any limitation on functions and use scope of the embodiments of this disclosure.

As shown in FIG. 10, the computer system 1000 includes a central processing unit (CPU) 1001, which may execute various proper actions and processing based on a program stored in a read-only memory (ROM) 1002 or a program loaded from a storage part 1008 into a random-access memory (RAM) 1003. The RAM 1003 further has various programs and data required for system operations stored therein. The CPU 1001, the ROM 1002, and the RAM 1003 are connected to each other via a bus 1004. An input/output (I/O) interface 1005 is also connected to the bus 1004.

The following components are connected to the I/O interface 1005: an input part 1006 including a keyboard, a mouse, and the like; an output part 1007 including, for example, a cathode ray tube (CRT), a liquid crystal display (LCD), and a speaker; the storage part 1008 including a hard disk and the like; and a communication part 1009 including a network interface card such as a local area network (LAN) card or a modem. The communication part 1009 performs communication processing over a network such as the Internet. A driver 1010 is also connected to the I/O interface 1005 as needed. A removable medium 1011, such as a magnetic disk, an optical disc, a magneto-optical disk, or a semiconductor memory, is installed on the drive 1010 as needed, whereby a computer program read from the removable medium is installed into the storage part 1008 as needed.

In some examples, according to the embodiments of this disclosure, the processes described in the various method flowcharts may be implemented as computer software programs. For example, the embodiments of this disclosure include a computer program product, which includes a computer program carried on a computer-readable medium. The computer program includes program code configured for implementing the methods shown in the flowcharts. In such an embodiment, the computer program may be downloaded and installed over a network through the communication part 1009, and/or installed from the removable medium 1011. The CPU 1001 executes the computer program to implement various functions defined in the system of this disclosure.

In addition, the computer-readable medium provided in the embodiments of this disclosure may be a computer-readable signal medium, a computer-readable storage medium, or any combination of the two. The computer-readable storage medium may be, for example, but is not limited to, an electric, magnetic, optical, electromagnetic, infrared, or semi-conductive system, apparatus, or component, or any combination thereof. More specific examples of the computer-readable storage medium may include, but are not limited to, an electrical connection with one or more conductors, a portable computer disk, a hard disk, an RAM, an ROM, an erasable programmable ROM (EPROM), a flash memory, an optical fiber, a portable compact disc ROM (CD-ROM), an optical storage device, a magnetic storage device, or any appropriate combination thereof. In this disclosure, the computer-readable storage medium may be any tangible medium containing or storing a program, and the program may be used by or used in combination with an instruction execution system, an apparatus, or a device. In this disclosure, the computer-readable signal medium may include a data signal being in a baseband or propagated as a part of a carrier wave, and carry computer-readable program code. A data signal propagated in such a way may assume a plurality of forms, including but not limited to, an electromagnetic signal, an optical signal, or any appropriate combination thereof. The computer-readable signal medium may further be any computer-readable medium other than the computer-readable storage medium. The computer-readable medium may transmit, propagate, or transfer a program that is used by or used in combination with an instruction execution system, an apparatus, or a device. The program code included on the computer-readable medium may be transmitted by any appropriate medium, including but not limited to, a wireless medium, a wired medium, or any appropriate combination thereof.

The flowcharts and block diagrams in the accompanying drawings illustrate possible system architectures, functions and operations that may be implemented by the system, the method, and the computer program product according to the embodiments of this disclosure. Based on this, each box in the flowchart or the block diagram may represent a module, a program segment, or a part of code. The module, the program segment, or the part of code includes one or more executable instructions configured for implementing designated logic functions. In some alternative implementations, functions annotated in boxes may occur in a sequence different from that annotated in the accompanying drawing. For example, actually two boxes shown in succession may be performed basically in parallel, and sometimes the two boxes may be performed in a reverse sequence. This is determined by a related function. Each box in the block diagram or the flowchart and a combination of boxes in the block diagram or the flowchart may be implemented by using a dedicated hardware-based system configured to implement a specified function or operation, or may be implemented by using a combination of dedicated hardware and computer instructions.

Although a plurality of modules or units of a device configured to perform actions are discussed in the foregoing detailed description, such division is not mandatory. In practice, according to the implementations of this disclosure, the features and functions of two or more modules or units described above may be embodied by one module or unit. On the contrary, the features and functions of one module or unit described above may be further divided to be embodied by a plurality of modules or units.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

According to the foregoing descriptions of the implementations, those skilled in the art may understand that the exemplary implementations described herein may be implemented by using software, or may be implemented by combining software and necessary hardware. Therefore, the technical solutions in the embodiments of this disclosure may be implemented in the form of a software product. The software product may be stored in a non-volatile storage medium (which may be a CD-ROM, a Universal Serial Bus (USB) flash drive, a removable hard disk, or the like) or on a network, including several instructions for instructing a computing device (which may be a personal computer, a server, a touch terminal, a network device, or the like) to perform the methods according to the implementations of this disclosure.

This disclosure is intended to cover any variations, uses, or adaptive changes of this disclosure.

This disclosure is not limited to the precise structures described above and shown in the accompanying drawings, and various modifications and changes may be made without departing from the scope of this disclosure.

What is claimed is:

1. A method of processing a point cloud file, comprising:
acquiring the point cloud file encapsulating a point cloud bitstream, a data box of the point cloud bitstream comprising a unit type field that indicates a data type from a plurality of data types for at least a data unit in the point cloud bitstream;
decapsulating the point cloud file; and
decoding the point cloud file according to the unit type field to obtain point cloud media content, the point cloud media content being obtained from at least the data unit of the data type when the data type is a specified data type of the plurality of data types.

2. The method according to claim 1, wherein the data type from the plurality of data types comprises a point cloud attribute slice of an unspecified attribute type or a point cloud attribute slice of a specified attribute type.

3. The method according to claim 2, wherein:
the point cloud file comprises one or more attribute component tracks that encapsulate a plurality of groups of attribute data;
when the plurality of groups of attribute data is encapsulated within a single attribute component track, a data type of a data unit in the single attribute component track is a point cloud attribute header or the point cloud attribute slice of the unspecified attribute type; and
when the plurality of groups of attribute data is encapsulated within a plurality of attribute component tracks, a data type of a data unit in an attribute component track in the plurality of attribute component tracks is a point cloud attribute header or the point cloud attribute slice of the specified attribute type.

4. The method according to claim 3, wherein:
the point cloud file further comprises a geometry component track that encapsulates geometry data; and
a data type of a data unit in the geometry component track is at least one of a point cloud sequence header, a point cloud geometry header, a point cloud frame header, or a point cloud geometry slice.

5. The method according to claim 4, wherein the plurality of groups of attribute data and the geometry data are encapsulated within a same point cloud track.

6. The method according to claim 2, wherein when the data type of the data unit is the point cloud attribute slice of the specified attribute type, a data structure of the data unit that is a point cloud attribute slice comprises a slice data type field, and the slice data type field indicates the specified attribute type.

7. The method according to claim 6, wherein:
the data unit comprises at least one of a point cloud attribute slice header or a point cloud attribute data bitstream;
a data structure of the point cloud attribute slice header comprises the slice data type field and a slice identifier field, and the slice identifier field indicates an identifier of the point cloud attribute slice; and
a data structure of the point cloud attribute data bitstream comprises the slice data type field and a parameter set flag field, and the parameter set flag field indicates a parameter set to use when the point cloud attribute data bitstream is decoded.

8. The method according to claim 2, wherein:
the point cloud file comprises one or more first point cloud slice tracks that encapsulate attribute data of a plurality of point cloud slices;
when the attribute data of the plurality of point cloud slices is encapsulated within a single first point cloud slice track, a data type of a data unit in the single first point cloud slice track is the point cloud attribute slice of the unspecified attribute type; and
when a part of the attribute data of the plurality of point cloud slices is encapsulated within a first point cloud slice track in the one or more first point cloud slice tracks, a data type of a data unit in the first point cloud slice track is the point cloud attribute slice of the specified attribute type.

9. The method according to claim 8, wherein:
the point cloud file further comprises a second point cloud slice track that encapsulates geometry data of the plurality of point cloud slices; and
a data type of a data unit in the second point cloud slice track is a point cloud geometry slice.

10. The method according to claim 9, wherein the attribute data of the plurality of point cloud slices and the geometry data of the plurality of point cloud slices are encapsulated within a same point cloud slice track.

11. The method according to claim 8, wherein:
the point cloud file further comprises a point cloud slice base track that encapsulates parameter information of the plurality of point cloud slices; and
the unit type field indicates that a data type of a data unit in the point cloud slice base track is at least one of a point cloud sequence header, a point cloud geometry header, a point cloud attribute header, or a point cloud frame header.

12. The method according to claim 1, wherein:
the point cloud file comprises one or more point cloud tracks that encapsulate the point cloud bitstream;
at least a point cloud track in the one or more point cloud tracks comprises a plurality of point cloud samples;
at least a point cloud sample in the plurality of point cloud samples comprises one or more sub-samples;
a data box of a sub-sample in the one or more sub-samples comprises a type flag field; and
the type flag field indicates a sub data type of the sub-sample.

13. The method according to claim 12, wherein:
when a value of the type flag field is a preset first value, the sub data type of the sub-sample is the data type indicated by the unit type field in the data box of the point cloud bitstream; and
when a value of the type flag field is a second value different from the preset first value, the sub data type of the sub-sample is not the data type indicated by the unit type field in the data box of the point cloud bitstream.

14. The method according to claim 13, wherein:
when the value of the type flag field is the preset first value, and the data type indicated by the unit type field in the data box of the point cloud bitstream is a type related to a point cloud slice,
the data box of the sub-sample further comprises a slice identifier field, and
the slice identifier field indicates an identifier of the point cloud slice.

15. The method according to claim 2, wherein when the data type of the data unit in the point cloud bitstream comprises the point cloud attribute slice of the specified attribute type, the data box of the point cloud bitstream further comprises:
a set attribute flag field, indicating whether a parameter set to be referenced when the point cloud attribute slice is decoded is a target parameter set in a point cloud attribute header.

16. The method according to claim 15, wherein:
the point cloud attribute header of the point cloud bitstream comprises one or more parameter sets of the specified attribute type;
when the point cloud attribute header comprises a single parameter set of the specified attribute type, the target parameter set is the single parameter set in the point cloud attribute header; and
when the point cloud attribute header comprises a plurality of parameter sets associated with the specified attribute type, the target parameter set is determined according to a specified position order of the plurality of parameter sets.

17. The method according to claim 2, wherein when the data unit in the point cloud bitstream comprises the point cloud attribute slice of the specified attribute type, the data box of the point cloud bitstream further comprises:
a parameter set flag field, indicating, in a point cloud attribute header, a position order of a parameter set to be referenced when the point cloud attribute slice is decoded.

18. The method according to claim 17, wherein the position order is a set arrangement order of a plurality of parameter sets associated with the specified attribute type.

19. An apparatus for processing a point cloud file, comprising processing circuitry configured to:
acquire the point cloud file encapsulating a point cloud bitstream, a data box of the point cloud bitstream comprising a unit type field that indicates a data type from a plurality of data types for at least a data unit in the point cloud bitstream;
decapsulate the point cloud file; and
decode the point cloud file according to the unit type field to obtain point cloud media content, the point cloud media content being obtained from at least the data unit of the data type when the data type is a specified data type of the plurality of data types.

20. A non-transitory computer-readable storage medium storing instructions which when executed by at least one processor cause the at least one processor to perform:
acquiring a point cloud file encapsulating a point cloud bitstream, a data box of the point cloud bitstream comprising a unit type field that indicates a data type from a plurality of data types for at least a data unit in the point cloud bitstream;
decapsulating the point cloud file; and
decoding the point cloud file according to the unit type field to obtain point cloud media content, the point cloud media content being obtained from at least the data unit of the data type when the data type is a specified data type of the plurality of data types.
